(19) United States
(12) Patent Application Publication
(10) Pub. No.: US 2005/0192136 A1
(43) Pub. Date: Sep. 1, 2005

(54) Variable diameter sprocket

(76) Inventor: John Allard, Saint-Jean-des-Piles (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/788,567

(22) Filed: Feb. 27, 2004

(51) Int. Cl. F16H 55/30; F16H 55/52

(52) U.S. Cl. 474/47

(57) ABSTRACT

A variable diameter sprocket including a support and at least three radially movable sprocket portions mounted to the support. A diameter changing mechanism is provided to selectively move the sprocket portions.

### FIELD OF THE INVENTION

The present invention relates to sprockets. More specifically, the present invention is concerned with a variable diameter sprocket to be used in chain driven applications. BACKGROUND OF THE INVENTION

Variable diameter sprockets are well known in the art. For example, U.S. Pat. Nos. 4,030,373; 4,832,660; 5,041,061; 5,013,284; 5,094,653; and 5,104,357 all naming Hamlin Leonard as an inventor, each describes variable speed drive systems for bicycles provided with variable diameter pulleys. As is well known, by modifying the diameter of the variable diameter pulley, the ratio of the front to rear pulleys is modified without requiring a cluster of sprockets.

The systems described by Leonard do not use a conventional bicycle chain but instead use a flexible driving means under the form of a V-belt. The different mechanisms described by Leonard have the same common drawback that the diameter changing mechanisms provided to modify the diameter of the pulley are generally complex.

The use of a V-belt is also a drawback since it must usually be heavily tensioned to prevent it from slipping from the pulleys. It is also to be noted that adverse temperature conditions, such as rain, may nevertheless cause the V-belt to slip in the pulleys.

To overcome the drawbacks described hereinabove with respect to the systems proposed by Leonard, the applicant describes in an international application published under publication number WO99/43539, a variable ratio drive system using a conventional chain and a simple sprocket diameter changing mechanism. It has been found however, that the friction between the sprocket diameter changing mechanism and the sprocket portions is somewhat detrimental to the performance of the drive system.

U.S. Pat. No. 6,332,852 issued Dec. 25, 2001 and naming John Allard as an inventor improves on the above variable ratio drive system by making a unitary sprocket diameter changing element and by improving the general concept. However, it has been found that some noise generated by the sprocket diameter changing element could be improved on.

### OBJECTS OF THE INVENTION

An object of the present invention is therefore to provide an improved quiet variable ratio drive system.

### SUMMARY OF THE INVENTION

More specifically, in accordance with an aspect of the present invention, there is provided a variable diameter sprocket comprising:
a support having a rotation axis and at least three slotted and radial track elements each provided with at least two stopping elements;
at least three sprocket portions, each being so mounted to a respective one of said at least three radial track elements of said support as to be radially movable therein; each of said at least three sprocket portions includes a movable element configured and sized to interconnect with said at least two stopping elements to selectively maintain the sprocket portion in a desired radial position; each sprocket portion also includes a biasing element mounted thereto to bias said movable element towards said at least two stopping elements;
a sprocket diameter changing mechanism including a fixed portion and a movable portion mounted to said fixed portion; said movable portion including a pushing surface so positioned and configured as to overcome a biasing action of said biasing element through a pushing action on said movable element of said sprocket portion; said pushing action causing the disengagement of said movable element from one of said stopping element; said movable portion including at least one guiding surface configured and sized to reposition said sprocket portion in a second desired radial position; said movable portion also including a throat so configured, positioned and sized as to cease the pushing action of the pushing surface when said sprocket portion has reached said second desired radial position so as to engage said movable element with a stopping element corresponding to the second desired radial position.

According to another aspect of the present invention, there is provided a variable diameter sprocket comprising:
a support having a rotation axis and at least three slotted and radial track elements each provided with at least two stopping elements;
at least three sprocket portions, each being so mounted to a respective one of said at least three radial track elements of said support as to be radially movable therein; each of said at least three sprocket portions includes a movable element configured and sized to selectively interconnect with said at least two stopping elements to selectively maintain the sprocket portion in a desired radial position;
a sprocket diameter changing mechanism including a fixed portion and a movable portion mounted to said fixed portion; said movable portion including a pushing surface so positioned and configured as to disconnect said movable element of said sprocket portion from one of said at least two stopping elements; said movable portion including at least one guiding surface configured and sized to reposition said sprocket portion in a second desired radial position; said movable portion also including a throat so configured, positioned and sized as to cease the pushing action of the pushing surface when said sprocket portion has reached said second desired radial position so as to engage said movable element with a stopping element corresponding to the second desired radial position; said throat being so configured and sized that it does not contact said sprocket portion.

According to another aspect of the present invention, there is provided a variable diameter sprocket comprising:
a support having a rotation axis and at five slotted and radial track elements each provided with six frusto-conical indentations;
five sprocket portions each being so mounted to a respective one of said five radial track elements of said support as to be radially movable therein; each of said sprocket portions includes a pin so slidably mounted in a aperture of said sprocket portion as to interconnect with said six stopping elements to selectively maintain the sprocket portion in a desired radial position; each sprocket portion also includes a biasing element mounted thereto to bias said slidable pin towards said six stopping elements; said pin including a first free end and a second end configured and sized to selectively interconnect with said six frusto-conical incentations; each said sprocket portion also including a peripheral projection surrounding said aperture;
a sprocket diameter changing mechanism including a fixed portion and a movable portion mounted to said fixed portion; said movable portion including a pushing surface so positioned and configured as to overcome a biasing action of said biasing element through a pushing action on said free end of said slidable pin; said pushing action causing the disengagement of said second end of said pin from one of said six stopping elements; said movable portion including at least one guiding surface configured and sized to contact said peripheral projection to reposition said sprocket portion in a second desired radial position; said movable portion also including a throat so configured, positioned and sized as to cease the pushing action of the pushing surface when said sprocket portion has reached said second desired radial position so as to engage said second end of said pin with a stopping element corresponding to the second desired radial position.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 is a side elevational view of a bicycle provided with a quiet variable ratio drive system according to an embodiment of the present invention, the drive system being provided with a front variable diameter sprocket;

FIG. 2 is an exploded perspective view of the front variable diameter sprocket of FIG. 1, illustrating the various elements forming one of the five movable sprocket portions;

FIG. 3 is a perspective view of a sprocket diameter changing mechanism of the variable ratio drive system of FIG. 1;

FIG. 4 is a perspective view of a movable sprocket portion of the variable ratio drive system of FIG. 1;

FIG. 5 is a side elevational view of a portion of the front sprocket of FIG. 1, illustrated in a position where one of the sprocket portions is about to be moved;

FIG. 6 is a sectional view of a portion of FIG. 5 illustrating the locking stem in its fully extended position before it contacts one of the ramp;

FIG. 7 is a sectional view taken along line 7-7 of FIG. 6;

FIG. 8 is a side elevational view similar to FIG. 5, where one of the sprocket portion is being moved;

FIG. 9 is a sectional view of a portion of FIG. 8 illustrating the locking stem in its fully retracted position and where the shoulder contacts one of the angled walls of the guide;

FIG. 10 is a sectional view taken along line 10-10 of FIG. 9;

FIG. 11 is a side elevational view similar to FIG. 5, where the displacement of one of the sprocket portion is completed; and

FIG. 12 is a sectional view of a portion of FIG. 11 illustrating the locking stem in its fully extended position free of any contact with the guide.

### DETAILED DESCRIPTION

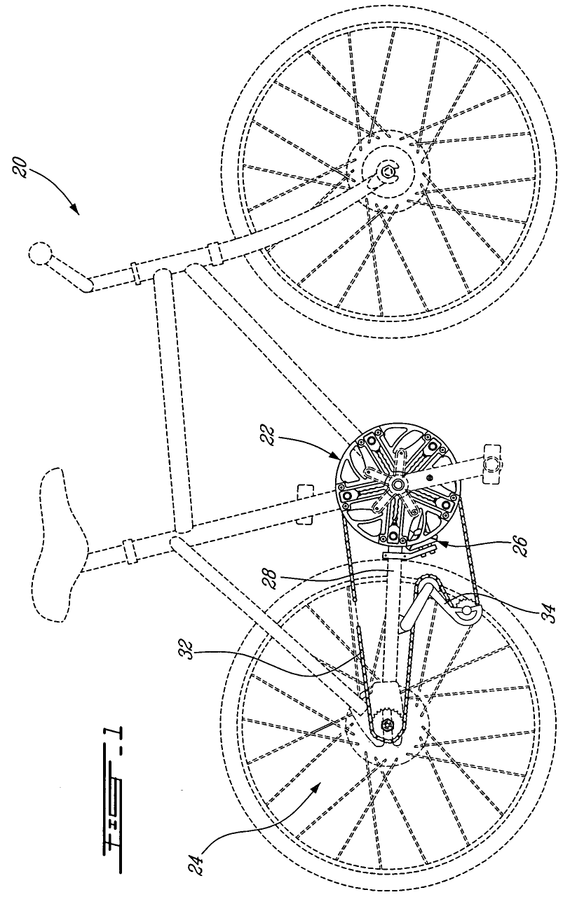

FIG. 1 schematically illustrates, in dashed lines, a bicycle 20 provided with a variable ratio drive system including a front variable diameter sprocket 22, a conventional rear sprocket 24 and a front sprocket diameter changing mechanism 26, mounted to a proximate portion of the chain stay 28 of the bicycle 20.

These two sprockets 22 and 24 are linked through a conventional bicycle chain 32 that is kept under proper tension by a chain tensioning mechanism 34.

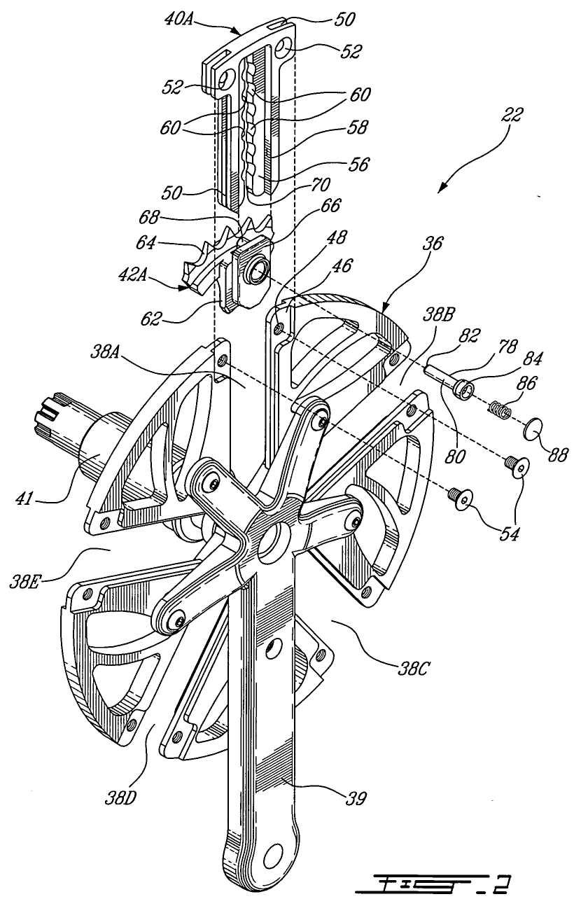

As can be seen from FIG. 2, the front variable diameter sprocket 22 includes a generally circular support 36 provided with five apertures 38A-38E each configured and sized to receive a corresponding track element 40A-40E (only 40A shown in FIG. A); five sprocket portions 42A-42E (only 42A shown in FIG. 2).

The apertures 38A-38E extend from a central portion to a peripheral portion of the support 36.

The circular support 36 is conventionally mounted to a pedal crank 39 and to a shaft 41.

For concision purposes, only the features of aperture/track/sprocket portion 38A/40A/42A, which are identical to the features of the other assemblies B to E, will be described herein.

Both sides of the aperture 38A define a tongue 44 having a shoulder portion 46 provided with a mounting hole 48. Correspondingly, the track element 40A is generally T-shaped and both its sides are provided with a channel 50 configured and sized to slide onto the tongues 44 of the aperture 38A. The cross-member of the track element 40A is provided with two mounting holes 52 allowing the track element 40A to be removably mounted to the aperture 38A of the support 36 via machine screws 54.

The central portion of the track element 40A includes a slofted recess 56 provided with walls 58 (only one shown) and includes six frusto-conical indentations 60 on either side. These indentations 60 define stopping elements as will be described hereinbelow.

As can be better seen from FIG. 4 of the appended drawings, the movable sprocket portion 42A includes a body 62 to which is mounted a dented portion 64; a slide portion 66 configured and sized to slide into the slotted recess 56 of the track element 40A; and a elongated connecting portion 68 configured and sized to enter the slot 70 (FIG. 2) of the track element 40A. The body 62 also includes a peripheral projection 72 configured and sized to contact the front sprocket diameter changing mechanism 26 as will be described hereinbelow. An aperture 74 traverses the sprocket portion 42A, including the slide portion 66, the body 62 and the peripheral projection 72. The aperture 74 includes a shoulder portion 76.

Returning to FIG. 2 of the appended drawings, the sprocket portion 42A also includes a pin 78 having a shank 80 provided with a rounded free end 82 and a hollow head 84 configured to receive a spring 86. The external surface of the hollow head 84 is configured and sized to fit into the indentations 60 of the slotted track portion 40A.

When the pin 78 is slidably mounted to the aperture 74, the spring 86 is inserted in the head 84 and a cap 88 is pressed-fitted in the shoulder portion 76 of the aperture 74. The spring therefore acts as a biasing element, forcing the pin in its fully extended position as will be described hereinbelow.

As will be apparent to one skilled in the art, the pin 78 defines, with the complementary indentations 60 of the slotted track portion 40A, a selective locking mechanism allowing, in this case, to lock the movable sprocket portions 42A in six (6) radial positions, thereby yielding a variable diameter sprocket having six (6) possible diameters.

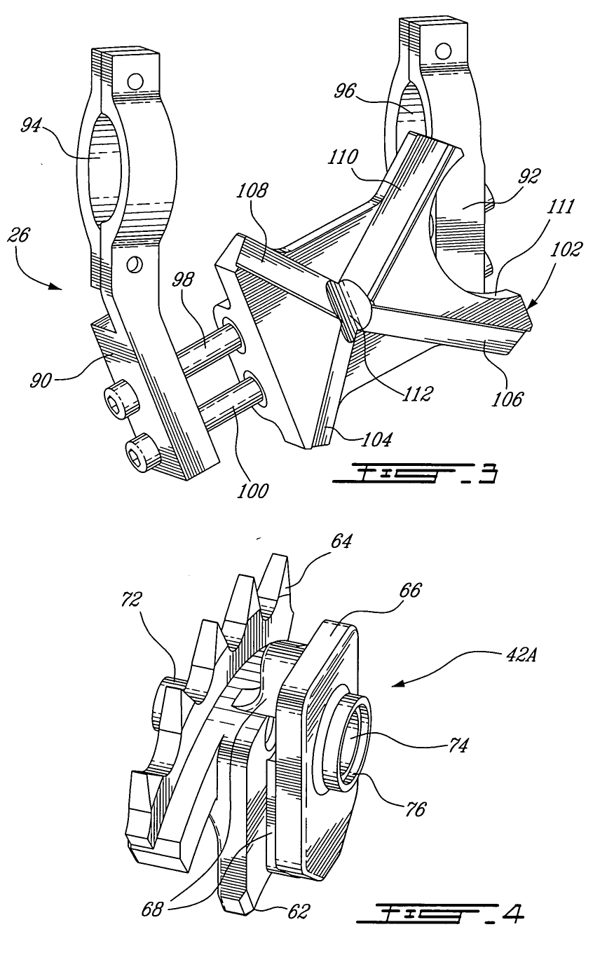

Referring now to FIGS. 2 and 3, the front sprocket diameter changing mechanism 26 will be described. This mechanism 30 includes two brackets 90 and 92 provided with apertures 94, 96 to mount them to the bicycle. Two guiding rods 98, 100 join the two brackets 94, 96. A movable guide 102 includes two apertures 104, 106 allowing the guide 102 to slide onto the rods 98, 100. The mechanism 26 also includes means (not shown) to selectively move the guide 102 onto the rods 98, 100 and maintain the guide at predetermined lateral position therein. These types of positioning means are believed to be known to those skilled in the art and will therefore not be discussed in details herein.

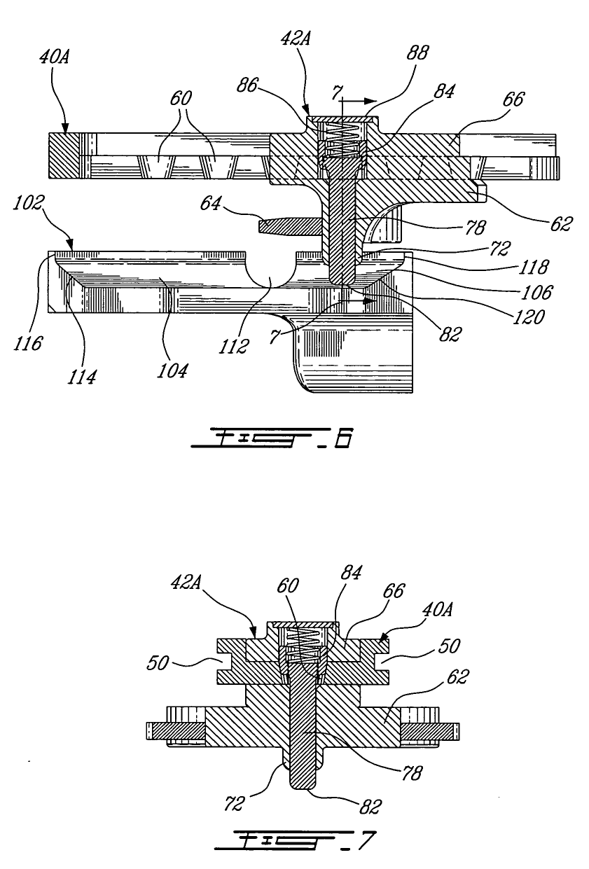

The guide 102 will now be described with respect to FIGS. 3 and 6. The guide 102 includes first and second forward ramps 104 and 106 and first and second backward ramps 108 and 110. These four ramps generally define an X-shaped pattern and are separated by a throat 112 provided at the intersection of the four ramps. As will easily be understood by one skilled in the art after reading the ongoing description, the width and depth of the throat 112 is slightly larger than the projection 72 of the sprocket portion 40A. The guide 102 also includes a semi-circular cutout 111 configured and sized to allow the guide 102 to be positioned near the shaft 41 of the support 36.

As can be better seen from FIG. 6 of the appended drawings the first forward ramp 104 includes a ramp portion 114 and a shoulder portion 116. In a nutshell the ramp portion 114 is designed to counteract the biasing action of the spring 86 to force the retraction of the pin 78 while the shoulder 116 is designed to contact the projection 72 to move the sprocket portion as will be described hereinbelow.

It is to be noted that the second forward ramp 106 and both backward ramps 108 and 110 are identical to the first forward ramp 104 and will therefore not be further described herein. As will be easily understood, the ramp portions define pushing surfaces and the shoulder portions define guiding surfaces.

It is also to be noted that the projection 72 prevent the slidable pin 78 from contacting the shoulder portions of the ramp, thereby increasing the lifespan of the pin 78.

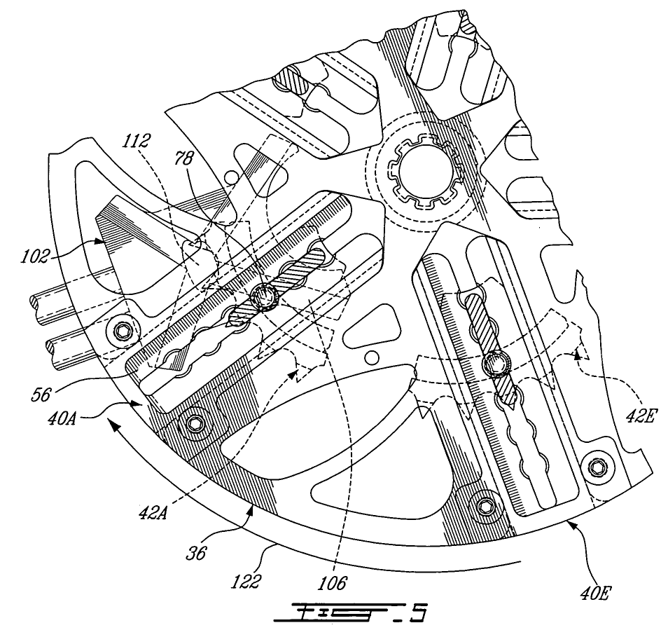

The operation of the front variable diameter sprocket 22 will now be described with reference to FIGS. 5 to 12.

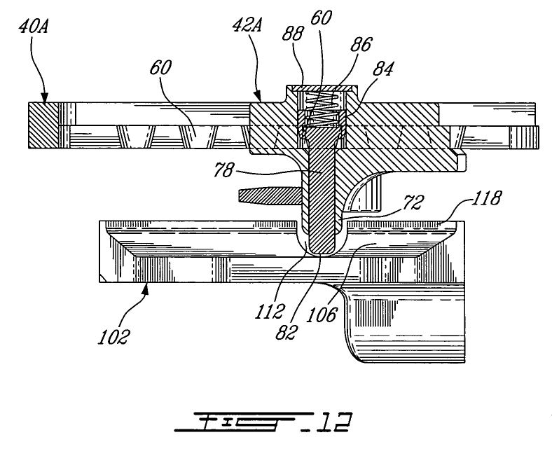

More specifically, FIGS. 5 to 7 illustrate the front variable diameter sprocket 22 just before the end 82 of the pin 78 of the sprocket portion 42A contacts the second forward ramp 106; FIGS. 8 to 10 illustrate the front variable diameter sprocket 22 as it is being moved by the contact of the projection 72 and the shoulder 118 of the second forward ramp 106; and FIGS. 11 and 12 illustrate the front variable diameter sprocket 22 when its movement from one position to another is done.

Turning now to FIGS. 5 to 7, its can be seen that the sprocket portion 42A is positioned in the third innermost indentation 60 of the track 40A, but that the guide 102 has been moved by the user so that the throat 112 is aligned with the fourth innermost indentation 60 of the track 40A. The consequence of this repositioning of the guide 102 is that the five movable sprocket portions 42A-42E will be moved from the third innermost indentation to the fourth innermost indentation in one complete turn of the support 36 (see arrow 122).

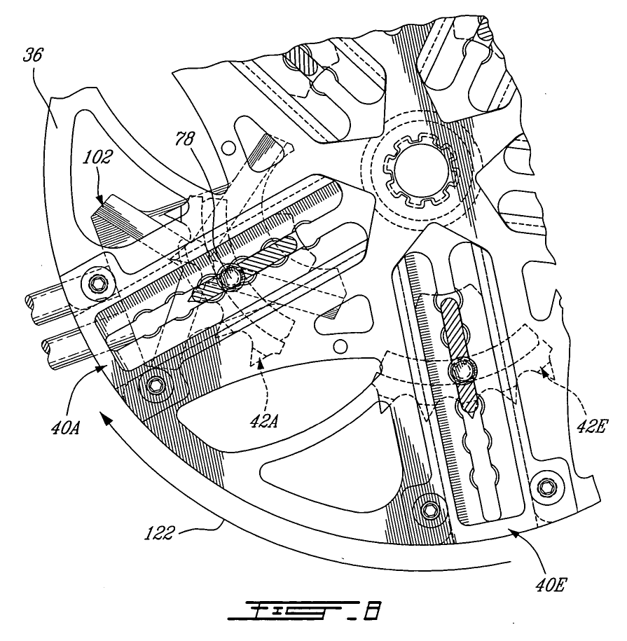

As can be better seen from FIG. 7, the head 84 of the pin 78 is seated in the indentation 60, therefore locking the sprocket portion 42A in this position.

Rotation of the support 36 in the direction of arrow 122 (FIG. 5) will cause the unlocking and the movement of the sprocket portion 42A.

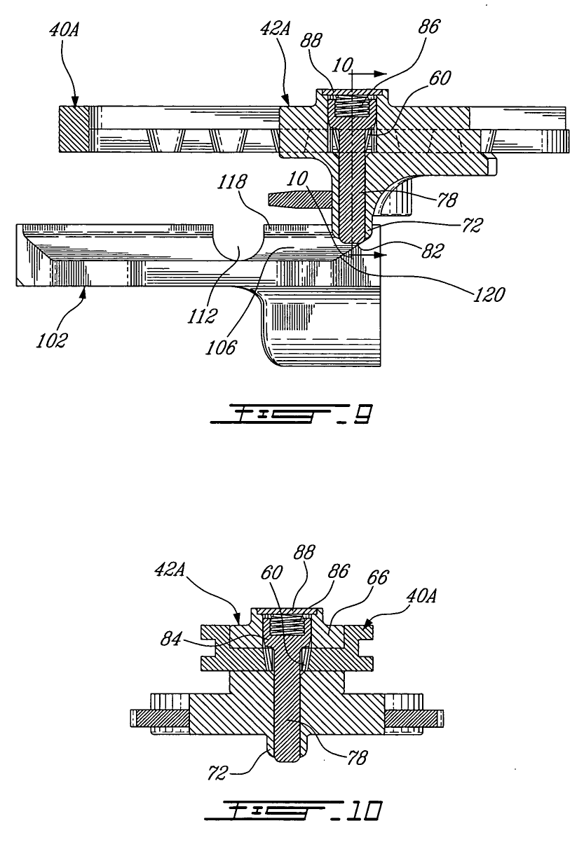

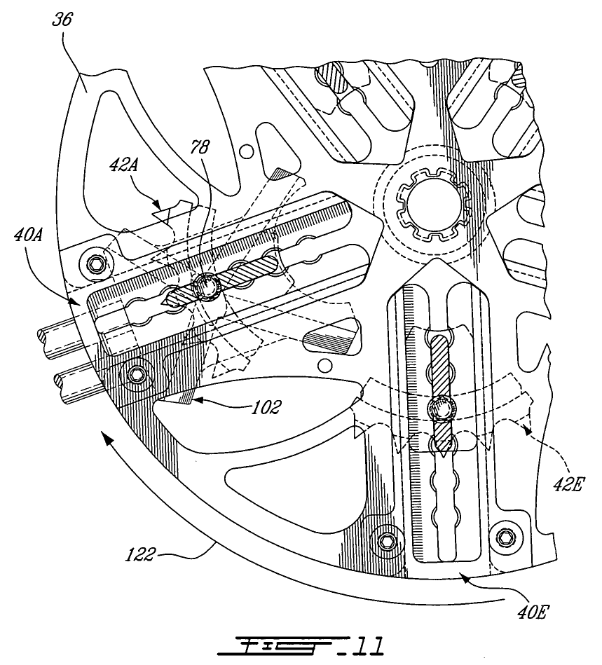

In FIG. 8 to 10, the sprocket portion 42A is moved from the third innermost indentation 60 to the fourth innermost indentation 60. As can be better seen from FIG. 9, the end 82 of the pin 78 has contacted the ramp portion 120 of the ramp 106 and the projection 72 has contacted the shoulder 118 of the ramp 106. The upward movement of the pin 78 causes the head 84 to overcome the biasing action of the spring 86 and to become free of the indentation 60 (FIG. 10).

This disengagement of the pin 78 from the track 40A allows radial outward movements of the sprocket portion 42A. This radial movement is forced by the contact between the projection 72 and the shoulder 118. Indeed, since the shoulder 118 is angled towards the throat 112, movement of the sprocket portion 42A will occur during the rotation of the support 36.

FIGS. 11 and 12 illustrate the sprocket portion 42A as it passes through the throat 112 of the guide 102. As can be better seen from FIG. 12, when the pin 78 reaches the throat 112, the end 82 no longer contacts the ramp 106 and the biasing action of the spring 86 forces the pin 78 into its fully extended position, engaging the head 84 of the pin 78 into an indentation 60.

It is to be noted that since both the indentations 60 and the head 84 of the pin 78 are slightly tapered, the alignment between theses elements needs not be perfect for their engagement to occur.

It is also to be noted that since the throat 112 is slightly larger than the pin 78/projection 72 combination, the sprocket portion 42A passes through the guide 102 silently when no diameter changes are requested by the user. Indeed, contact between the sprocket portion 42A and the guide 102 happens only when a diameter change is requested.

We can see from FIG. 11 that the continued rotation of the support 36 will bring the sprocket portion 42E in contact with the guide 42 to thereby move it as it has moved sprocket portion 42A.

Of course, the above description of the movement of the sprocket portion 42A from the third innermost indentation to the fourth innermost indentation has been given as an example only. The same principle of operation applies to any movement between adjacent indentations. Indeed, when the guide 102 is radially moved towards the center of the support 36, the angled wall 104 is used to correspondingly move the sprocket portions 42A-42E towards an innermost indentation, thereby reducing the diameter of the variable diameter sprocket 22.

It is to be noted that the sprocket diameter changing mechanism 26 is so positioned that it only contacts the movable sprocket portions when they are not engaged to the chain 32.

As will be easily understood by one skilled in the art, the rearward ramps 108 and 110 are used for example to allow a diameter change when the user is “back-pedaling”.

It is to be noted that a simple tensioning mechanism 34 can be used since the chain 32 is always in the same plane. As will easily be understood by one skilled in the art, since the chain 32 is generally maintained in a single plane, the chain tensioning mechanism 34 may be mounted anywhere on the chain stay 28.

Of course, the indentations 60 could be replaced by other types of stopping elements configured to cooperate with complementary movable elements to provide the functionality described hereinabove without departing from the present invention.

It is also to be noted that while the track elements 40A-40E have been illustrated herein as being separate elements, one skilled in the art will understand that should the material forming the support 36 be adequate, the slot 70 and the indentations 60 could be formed directly in the support 36. Should this be the case, the slot 70 could define peripheral openings in the support 36 that would be closed by separate elements (not shown) to improve the structural integrity and prevent the sprocket portions 42A-42E from being disengaged from the support 36.

While the above description and the appended drawings illustrate a front variable diameter sprocket, it is understood that one skilled in the art could designed a similar rear variable diameter sprocket.

The appended drawings do not illustrate a chain guide, often used to prevent the chain from being disengaged from the sprockets. However, a chain guide could be used with the present invention.

Although the present invention has been described hereinabove by way of preferred embodiments thereof, it can be modified, without departing from the spirit and nature of the subject invention as defined in the appended claims.

1. A variable diameter sprocket comprising:
a support having a rotation axis and at least three slotted and radial track elements each provided with at least two stopping elements;
at least three sprocket portions, each being so mounted to a respective one of said at least three radial track elements of said support as to be radially movable therein; each of said at least three sprocket portions includes a movable element configured and sized to interconnect with said at least two stopping elements to selectively maintain the sprocket portion in a desired radial position; each sprocket portion also includes a biasing element mounted thereto to bias said movable element towards said at least two stopping elements;
a sprocket diameter changing mechanism including a fixed portion and a movable portion mounted to said fixed portion; said movable portion including a pushing surface so positioned and configured as to overcome a biasing action of said biasing element through a pushing action on said movable element of said sprocket portion; said pushing action causing the disengagement of said movable element from one of said stopping element; said movable portion including at least one guiding surface configured and sized to reposition said sprocket portion in a second desired radial position; said movable portion also including a throat so configured, positioned and sized as to cease the pushing action of the pushing surface when said sprocket portion has reached said second desired radial position so as to engage said movable element with a stopping element corresponding to the second desired radial position.

2. A variable diameter sprocket as recited in claim 1, wherein said at least three slotted and radial track elements are removably mounted to said support.

3. A variable diameter sprocket as recited in claim 2, wherein said at least two stopping elements are generally frusto-conical indentations.

4. A variable diameter sprocket as recited in claim 1, wherein said movable element of each said sprocket portion includes a pin slidably mounted in an aperture of said sprocket portion; said pin including a first free end so configured and sized as to contact said pushing surface and a second end so configured and sized as to cooperate with said biasing element and with said stopping elements; said pin being slidable in said aperture between a fully extended position where said second end cooperates with said stopping elements to maintain said sprocket portion in a desired position and a fully retracted position where said sprocket portion is free to radially move within said track element.

5. A variable diameter sprocket as recited in claim 4, wherein said aperture includes a peripheral projection so configured and sized as to selectively contact said guiding surface of said movable portion of said sprocket diameter changing mechanism.

6. A variable diameter sprocket as recited in claim 4, wherein said biasing element includes a compression spring biasing said pin towards said fully extended position.

7. A variable diameter sprocket as recited in claim 1, wherein said pushing surface includes four angled ramp portions generally defining an X-shaped pattern and wherein said throat is generally located in the intersection of said four ramp portions.

8. A variable diameter sprocket as recited in claim 7, wherein each of said four ramp portions includes a shoulder defining said guiding portion.

9. A variable diameter sprocket comprising:
a support having a rotation axis and at least three slotted and radial track elements each provided with at least two stopping elements;
at least three sprocket portions, each being so mounted to a respective one of said at least three radial track elements of said support as to be radially movable therein; each of said at least three sprocket portions includes a movable element configured and sized to selectively interconnect with said at least two stopping elements to selectively maintain the sprocket portion in a desired radial position;
a sprocket diameter changing mechanism including a fixed portion and a movable portion mounted to said fixed portion; said movable portion including a pushing surface so positioned and configured as to disconnect said movable element of said sprocket portion from one of said at least two stopping elements; said movable portion including at least one guiding surface configured and sized to reposition said sprocket portion in a second desired radial position; said movable portion also including a throat so configured, positioned and sized as to cease the pushing action of the pushing surface when said sprocket portion has reached said second desired radial position so as to engage said movable element with a stopping element corresponding to the second desired radial position; said throat being so configured and sized that it does not contact said sprocket portion.

10. A variable diameter sprocket as recited in claim 9, wherein said at least three slotted and radial track elements are removably mounted to said support and wherein said at least two stopping elements are generally frusto-conical indentations.

11. A variable diameter sprocket as recited in claim 10, wherein said movable element of each said sprocket portion includes a pin slidably mounted in an aperture of said sprocket portion; said pin including a first free end so configured and sized as to contact said pushing surface and a second end so configured and sized as to cooperate with a biasing element and with said stopping elements; said pin being slidable in said aperture between a fully extended position where said second end cooperates with said stopping elements to maintain said sprocket portion in a desired position and a fully retracted position where said sprocket portion is free to radially move within said track element; said biaising element including a compression spring biasing said pin towards said fully extended position.

12. A variable diameter sprocket as recited in claim 11, wherein said aperture includes a peripheral projection so configured and sized as to selectively contact said guiding surface of said movable portion of said sprocket diameter changing mechanism, thereby preventing contact between said pin and said shoulder portion.

13. A variable diameter sprocket as recited in claim 9, wherein said pushing surface includes four angled ramp portions generally defining an X-shaped pattern and wherein said throat is generally located in the intersection of said four ramp portions.

14. A variable diameter sprocket as recited in claim 13, wherein each of said four ramp portions includes a shoulder defining said guiding portion.

15. A variable diameter sprocket comprising:
a support having a rotation axis and at five slotted and radial track elements each provided with six frusto-conical indentations;
five sprocket portions each being so mounted to a respective one of said five radial track elements of said support as to be radially movable therein; each of said sprocket portions includes a pin so slidably mounted in a aperture of said sprocket portion as to interconnect with said six stopping elements to selectively maintain the sprocket portion in a desired radial position; each sprocket portion also includes a biasing element mounted thereto to bias said slidable pin towards said six stopping elements; said pin including a first free end and a second end configured and sized to selectively interconnect with said six frusto-conical incentations; each said sprocket portion also including a peripheral projection surrounding said aperture;
a sprocket diameter changing mechanism including a fixed portion and a movable portion mounted to said fixed portion; said movable portion including a pushing surface so positioned and configured as to overcome a biasing action of said biasing element through a pushing action on said free end of said slidable pin; said pushing action causing the disengagement of said second end of said pin from one of said six stopping elements; said movable portion including at least one guiding surface configured and sized to contact said peripheral projection to reposition said sprocket portion in a second desired radial position; said movable portion also including a throat so configured, positioned and sized as to cease the pushing action of the pushing surface when said sprocket portion has reached said second desired radial position so as to engage said second end of said pin with a stopping element corresponding to the second desired radial position.
